(19) United States
(12) Patent Application Publication
(10) Pub. No.: US 2015/0024922 A1
(43) Pub. Date: Jan. 22, 2015

(54) CENTRIFUGATION SYSTEM AND RELATED METHOD

(71) Applicants: PALL TECHNOLOGY UK LIMITED, Portsmouth (GB); PALL ARTELIS BVBA, Brussels (BE)

(72) Inventors: Jose Antonio Castillo Gonzalez, Brussels (BE); Jean-Christophe Drugmand, Louvain-la-neuve (BE); Vishwas Pethe, Shakopee, MN (US); Alexandre Terentiev, Lexington, KY (US)

(21) Appl. No.: 14/376,514

(22) PCT Filed: Feb. 2, 2013
(86) PCT No.: PCT/US2013/024530

§ 371 Date: Aug. 4, 2014

Related U.S. Application Data
(60) Provisional application No. 61/594,077, filed on Feb. 2, 2012.

(51) Int. Cl. B04B 1/04; B04B 7/08; B04B 11/04

(52) U.S. Cl. CPC B04B 1/04; B04B 11/04; B04B 7/08
USPC 494/40; 494/45; 494/60

(57) ABSTRACT

In one aspect, a disposable centrifuge includes a container including an interior compartment for receiving the liquid and solids. The container is capable of rotating to urge the solids toward the periphery of the interior compartment. A fixed extraction conduit may be provided for extracting at least a portion of the solids from adjacent the periphery of the interior compartment of the container. A motive device may also be provided for forming a non-contact coupling with the container, which may rotate and/or levitate the container. A relatively low, continuous flow rate (about 250 ml/min to about 500 ml/min) may also be utilized. Related methods are also disclosed.

This application claims the benefit of and incorporates by reference U.S. Provisional Patent Application Ser. No. 61/594,077.

### TECHNICAL FIELD

This disclosure relates generally to the fluid handling arts and, more particularly, to systems for separating solids, such as cells, from a liquid, using centrifugal force.

### BACKGROUND

The use of centrifugation to separate a solid fraction, such as cells, from a liquid fraction, of a suspension is well known. Typically, the centrifuges used for collecting cells from a bioreactor are not disposable components, and in any case require a halting of the centrifugation process in order to allow for cell recovery. Moreover, existing devices that attempt to achieve such semi-continuous centrifugation invariably require dynamic seals to introduce the cell suspension to and extract the supernatant from the centrifuge. This adds to the cost and complexity, risks breaching sterility, and also potentially results in the generation of heat and particles (which is deleterious in the case of autologous cell seperaration, and in many cases will necessitate a costly and time consuming added filtration step). These existing devices also typically rely on high flow rates and excessive g-forces, which may destroy fragile cells.

Thus, a need is identified for a manner of providing an improved centrifuge. The centrifuge may at least rotate, and possibly levitate, as well, while the process of solids recovery is completed. Also, the arrangement may be such that the capacity of the separation compartment would be minimized to allow for a high separation efficiency at a relatively low flow rate (e.g., <1 liter/minute, and possibly as low as 0.25-0.5 milliliters/minute), even with the use of dynamic seals.

### SUMMARY

According to one aspect of this disclosure, an apparatus for use in performing centrifugation with a liquid including solids is disclosed. In one embodiment, the apparatus comprises a container including an interior compartment for receiving the liquid and solids. The container is capable of rotating to urge the solids toward the periphery of the interior compartment. A fixed extraction conduit is provided for extracting at least a portion of the solids from adjacent the periphery of the interior compartment of the container. A motive device is also provided for forming a non-contact coupling with the container.

The apparatus may also include a vessel for receiving the container. The vessel may have an inlet for introducing the liquid and solids to the container and a drain for draining at least liquid from the vessel. Any one of the inlet, the extraction conduit, or the drain may comprise a tube connected to a wall of the vessel by a static seal.

The motive device may rotate the container via the non-contact coupling. The motive device may also be adapted to levitate the container via the non-contact coupling. The motive device may be adapted to levitate and rotate the container via the non-contact coupling. The motive device may comprise a magnet, a superconductor or an electromagnet.

The container may include a bottom wall and an upstanding sidewall forming an at least partially open top. A lip may be provided adjacent the sidewall for assisting in retaining solids, such as cells, in the interior compartment during rotation. The container may comprise a rigid material, and may carry at least one magnet.

A further aspect of this disclosure relates to an apparatus for use in performing centrifugation on a liquid including solids. The apparatus comprises a vessel and an open-ended container mounted for rotating within the vessel. The container includes an interior compartment for receiving the liquid and solids. A motive device is also provided for rotating the container by way of a non-contact coupling.

In one embodiment, the motive device comprises a superconductor connected to a motor, and the container is adapted for forming a magnetic coupling with the superconductor. Alternatively, the motive device may comprise a magnet, and the container is adapted for forming a magnetic coupling with the magnet of the motive device. In the case where the motive device comprises a superconductor for levitating the container, a permanent magnet may be adapted for rotating to rotate the container via a magnetic coupling with the superconductor. A mechanical bearing may support the container for rotation relative to the vessel.

The container may include a lip along an upper portion for assisting in retaining cells in the interior compartment during rotation. A fixed extraction conduit may also be provided for extracting at least a portion of the solid. The extraction conduit may be adjacent the periphery of the interior compartment of the container.

Another aspect of this invention is an apparatus for use in performing substantially continuous centrifugation to separate cells from a liquid. The vessel is adapted for receiving the liquid, and a container is mounted for rotating within the vessel. The container includes an interior compartment for receiving the liquid, and the vessel includes an inlet for introducing the liquid to the interior compartment of the container, an extraction conduit from extracting cells from the interior compartment of the container, and a drain for draining at least liquid from the vessel.

The arrangement may further include a motive device for rotating the container relative to the vessel. A motive device may also be provided for levitating the container relative to the vessel. The extraction conduit may comprise a partially non-linear tube in the container, which may have a substantially open top.

A further aspect of this disclosure is an apparatus for use in performing substantially continuous centrifugation to separate cells from a liquid. The apparatus comprises a collapsible vessel and a container mounted for rotating within the vessel. The container includes an interior compartment for receiving the liquid.

In one embodiment, the vessel comprises a flexible bag. A motive device may also be provided for forming a non-contact coupling with the container. In any of the foregoing situations, the liquid flow rate may be from about 250 ml/min to about 500 ml/min.

A further aspect of the invention is an apparatus for use in performing centrifugation to separate cells from a liquid. The apparatus comprises a container mounted for rotation, the container including a first conduit for conveying the liquid to an interior compartment of the container and a second conduit for conveying liquid from the interior compartment, the first and second conduits each being connected to the container by way of a dynamic seal. A flow rate of the liquid is from about 250 ml/min to about 500 ml/min, and may be through one or more of the first conduit, the second conduit, or the interior compartment of the vessel.

Yet another aspect of this disclosure relates to a system including a bioreactor and any of the above-described apparatuses.

A method of centrifugation using a liquid including solids comprises rotating a container including the liquid, and during the rotating step, removing a major portion of the solids from the container. A method of centrifugation also comprises rotating a container including a liquid and cells, and during the rotating step, removing a major portion of the cells from the container. The method may further include the step of levitating the container within a vessel, and the removing step may comprise extracting the solids from adjacent the sidewalls of the container. The method may further include the step of conveying liquid from the container during the rotating step, which may involve overflowing a liquid fraction substantially free of cells from the container.

Another method of centrifugation comprises rotating a container including a liquid and cells and, during the rotating step, transmitting liquid substantially free of cells from the container. The transmitting step may comprise overflowing the liquid from the container.

In any of the foregoing methods, the liquid flow rate may be from about 250 ml/min to about 500 ml/min. In any of the foregoing cases, the container may have has a capacity of about 100 ml to about 300 ml, and possibly about 135 ml.

A further method for performing centrifugation to separate cells from a liquid comprises providing a container mounted for rotation, the container including a first conduit for conveying the liquid to an interior compartment of the container and a second conduit for conveying liquid from the interior compartment, the first and second conduits each being connected to the container by way of a dynamic seal. The method further includes the step of flowing liquid through the container at a rate of about 250 ml/min to about 500 ml/min.

An apparatus for use in performing centrifugation on a liquid including solids is also disclosed. The apparatus comprises a container including an interior compartment for receiving the liquid and solids, said container being capable of rotating, and a motive device for levitating the container. One of the motive device or the container comprises a magnet. One of the motive device or the container comprises a superconductor. The container may comprise an open-top bowl, and a fixed extraction conduit may extend into the container.

A further aspect of the disclosure pertains to a centrifuge including a disposable bag for receiving the liquid and solids, and means for separating the liquid from the solids. The separating means may comprise a container for receiving the liquid and solids within the disposable bag, the container being coupled to a motive device (such as a motor for rotating a magnet).

### BRIEF DESCRIPTION OF THE DRAWINGS

FIG. 1 is a schematic diagram illustrating a broad aspect of the disclosure;

FIG. 2 is a schematic diagram illustrating a specific embodiment of the disclosure;

FIG. 2a is a schematic diagram illustrating another specific embodiment of the disclosure;

FIG. 3 is a schematic diagram illustrating an embodiment of a system including the disclose centrifuge;

FIG. 4 is a partially cross-sectional, partially schematic view of yet another specific embodiment of the disclosure;

FIG. 4a is a partially cross-sectional, partially schematic view of still another specific embodiment of the disclosure;

FIG. 5 is a partially cross-sectional, partially schematic view of a further specific embodiment of the disclosure; and

FIG. 6 is a schematic view illustrating a further aspect of the disclosure.

### DETAILED DESCRIPTION

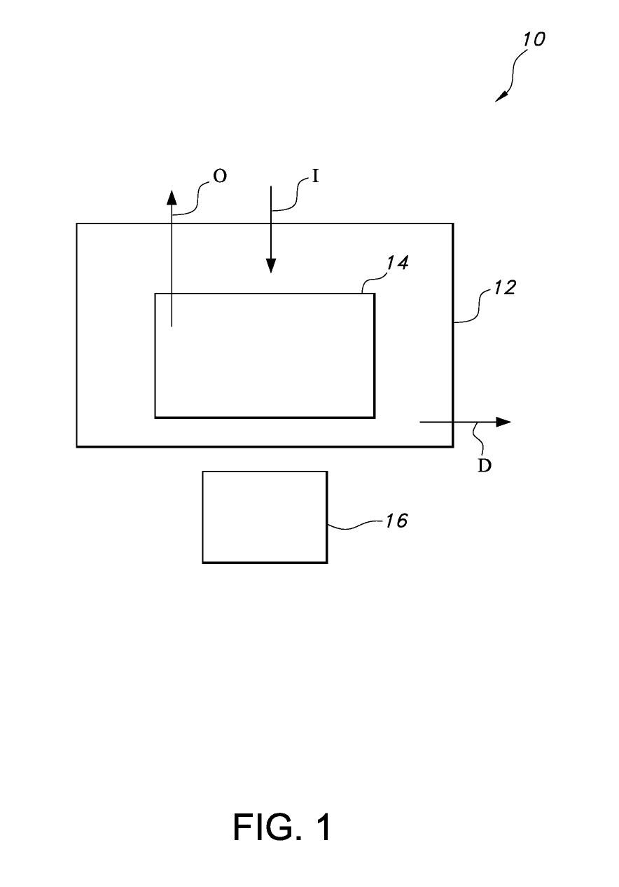

Reference is now made to FIG. 1, which illustrates a centrifugation system 10 according to the basic concepts of the disclosure. This system 10 includes a vessel 12 including an interior compartment for receiving a container 14 capable of moving within the compartment as the result of a non-contact coupling. A motive device 16 external to the vessel 12 provides the forces for achieving the movement (which as discussed herein may be a combination of levitation and rotation), and an inlet I is provided for introducing the suspension to an interior compartment of the container 14. An outlet O communicates with the container 14 along its periphery to recover the liquid dense with cells as the result of the centrifugal force created when the container 14 is rotated within the vessel 12. The separated liquid may flow out from the container 14 into the interior compartment of the vessel 12, and then be discharged through a drain D. A continuously operable and completely closed centrifugation system 10 thus results, without the need for dynamic seals or the like.

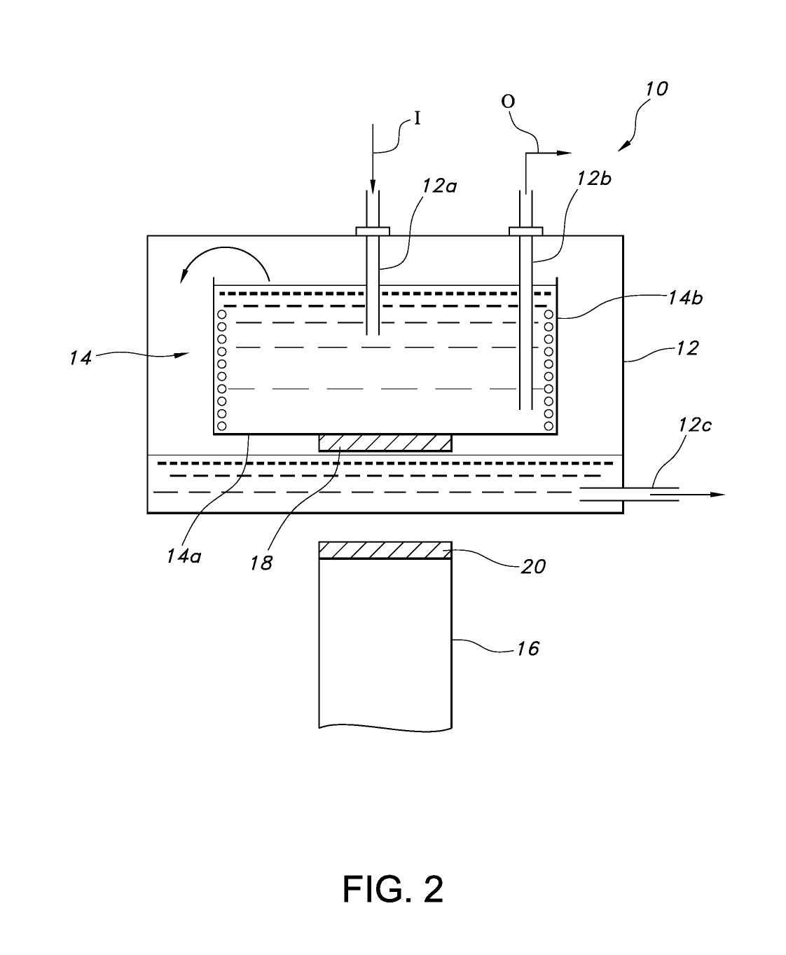

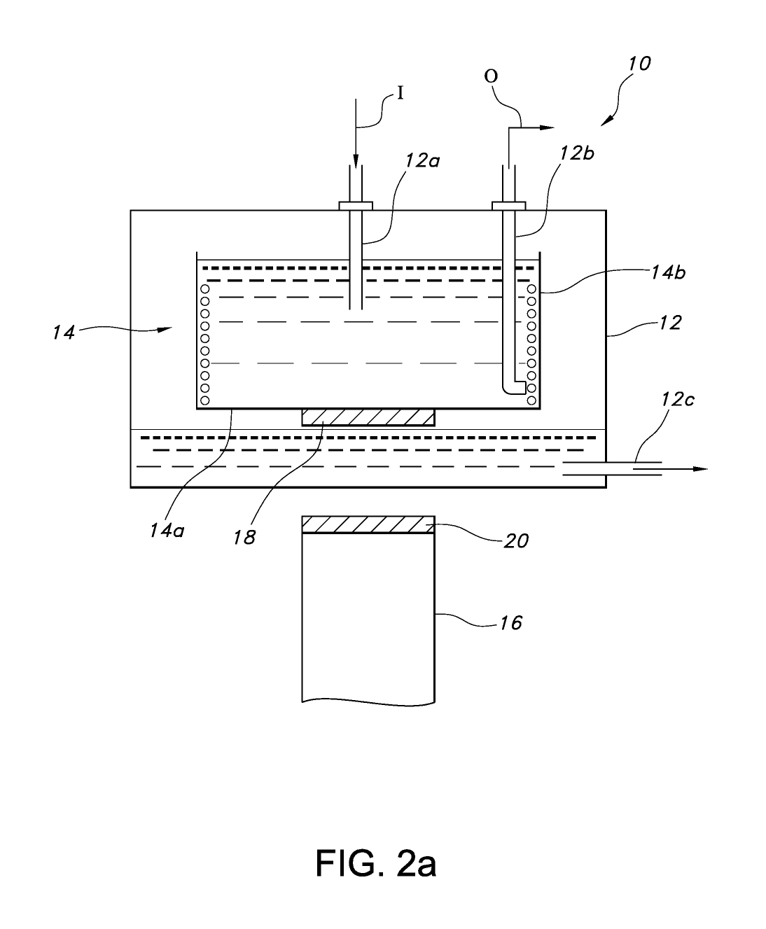

Turning to FIG. 2, one particular embodiment of the centrifugation system 10 is shown. The vessel 12 is this embodiment comprises a housing, which may be formed of a rigid material, such as hard plastic or metal. The inlet I may be provided by a tube 12a through the upper wall, such as at or near the center, and a similar tube 12b mounted closer to the periphery provides the extraction conduit, or outlet O. A third tube 12c along the lower portion of the vessel 12 provides the conduit for discharging the media.

The container 14 may also comprise a rigid or semi-rigid cup or bowl-shaped structure including a bottom wall 14a and an upstanding sidewall 14b forming an at least partially open top. The bottom wall 14a may support or carry one or more magnets 18, which are arranged to interface with the external motive device 16. The arrangement may be one that provides the container 14 with levitation and rotation in the absence of a physical bearing or the like. This may be achieved by using a field-cooled superconductor 20 as forming part of the motive device 16, which when rotated may provide both the levitational and rotational force for the container 14 via the magnetic coupling or pinning with the magnets 18. The details may be found in one or more of U.S. Pat. Nos. 6,416,215; 6,758,593; 6,837,613; 6,965,288 and 6,899,454, the disclosures of which are incorporated herein by reference. However, it is also possible to form other types of magnetic couplings, such as by using electromagnets or the like, that may achieve the levitation and rotation. Such systems are detailed in, for example, U.S. Pat. No. 5,141,327, the disclosure of which is incorporated herein by reference.

When the suspension is introduced into the rotating container 14, the interior compartment receives the liquid. The cells in this liquid are caused to move outwardly as the result of centrifugal force created by the rotation of the container 14. The extraction conduit formed by tube 12b is mounted adjacent to the periphery of the container 14, such as along the sidewall 14b. A pump (not shown) associated with the tube 12b may be used to apply a negative pressure and extract cell-rich liquid from the periphery of the container 14.

To provide continuous operation, it should be appreciated that the liquid will eventually line the vertical sides of the container 14 and may overflow from the open top. This liquid, which should be generally free of cells, flows into the interior compartment of the surrounding vessel 12. This liquid may be drained from the vessel 12 through tube 14c, and may be discarded or subjected to further processing (such as by recycling it to the inlet I). In one particular embodiment, shown in FIG. 2a, the container 14 includes a lip along its upper portion to help contain the cell-laden liquid in the interior compartment. In this embodiment, the tube 14c is shown as having a non-linear portion in the interior compartment to assist in recovering the cells that have migrated toward the inner sides of the container 14 as the result of the centrifugal force created by rotation.

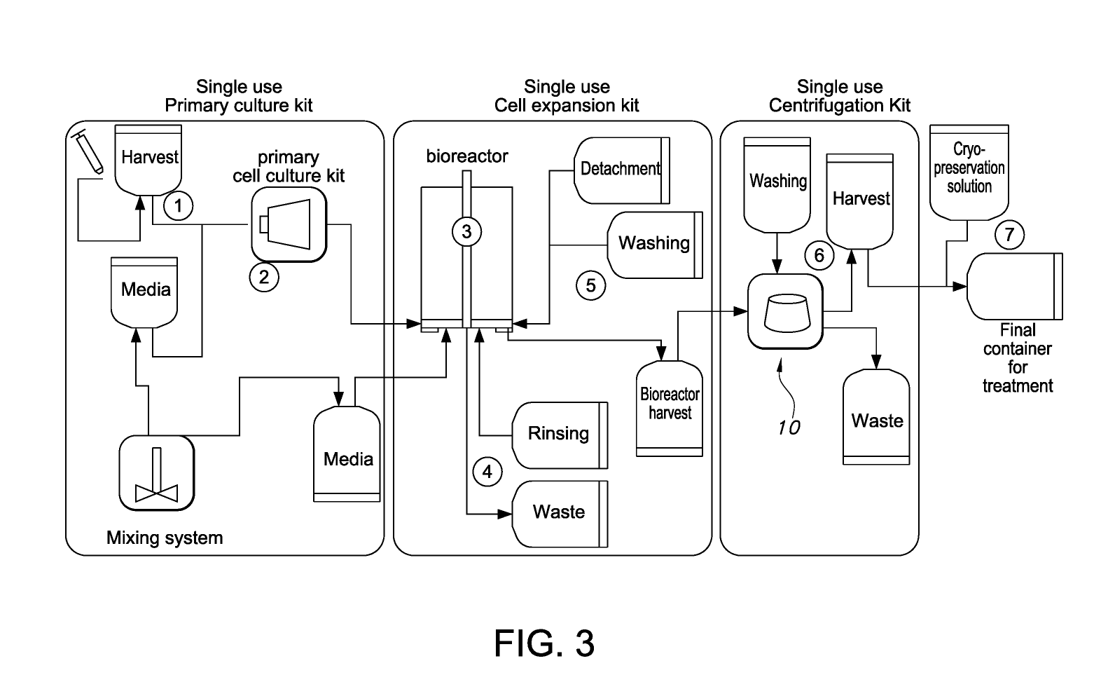

Once processing is complete, the vessel 12 including the container 14 may be discarded. As should be appreciated, this single-use arrangement allows for these combined structures to be made of inexpensive disposable materials, which advantageously eliminates the risk of cross-contamination and cleaning costs. The vessel 12 including the container 14 along with the various connections for conveying fluid may also be provided as part of a cartridge for integrating with a system including other disposable components, such as perhaps a bioreactor or like cell culture device (see FIG. 3).

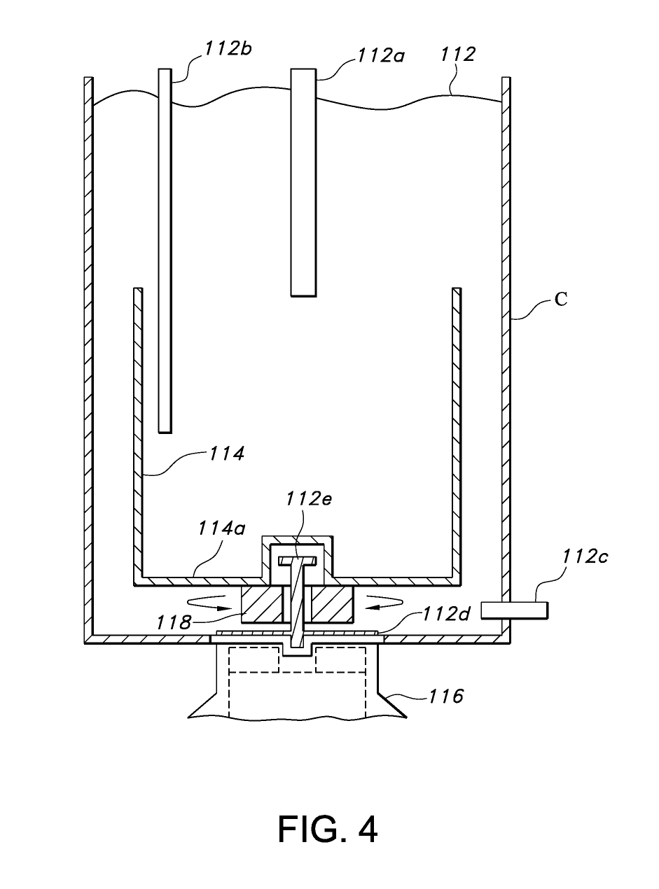

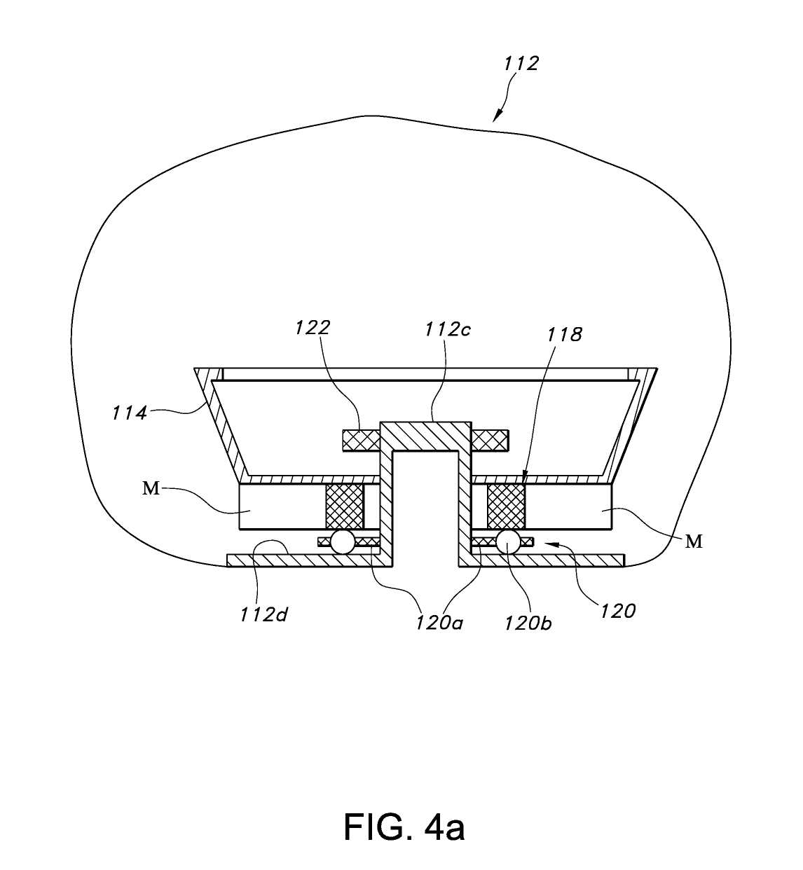

While the vessel 12 is described as being rigid or semi-rigid, it could take the form of a flexible bag 112 or the like, as shown in FIG. 4. The inlet 112a, outlet 112b, and drain 112c may be provided, as in the embodiment described above. The advantage is that the bag 112 may be folded and stored in a compact fashion prior to use, and then expanded. In this case, a support structure, such as a rigid container C may be provided for helping to ensure that the flexible walls of the bag do not collapse or interfere with the rotation of the container 114. The bag 112 may also include a rigid portion 112d along all or a portion of the bottom thereof, which may further include a retainer (such as a projection or post 112e) for receiving and retaining the container 114, such as by passing through an opening in magnet 118. The arrangement may be such that the levitation and rotation of the container 114 via the external motive device 116 is not hampered (e.g., there is no direct engagement between the retainer 112e and container 114, yet the structures remain coupled).

In an alternative embodiment, the container 114 may be arranged to be supported by a physical or mechanical bearing. For example, a roller bearing 120 may be provided between the magnet 118 and the rigid portion 112d (or, alternatively, between the matrix material M and the rigid portion 112d, or with the magnet 118 or the matrix material M and the retainer 112e). The bearing 120 may comprise a race 120a for retaining a rolling element, such as a ball 120b, roller, or the like. In such case, the motive device 116 need not supply a levitative force, but may instead serve to transmit rotational torque only (and thus may comprise a rotating magnet or like structure forming a non-contact coupling through the vessel 112). Examples of such bearing arrangements may be found in U.S. Patent Application Publication No. 20100157752, the disclosure of which is incorporated herein by reference. A removable retaining element 122 may also be provided for retaining the container 114.

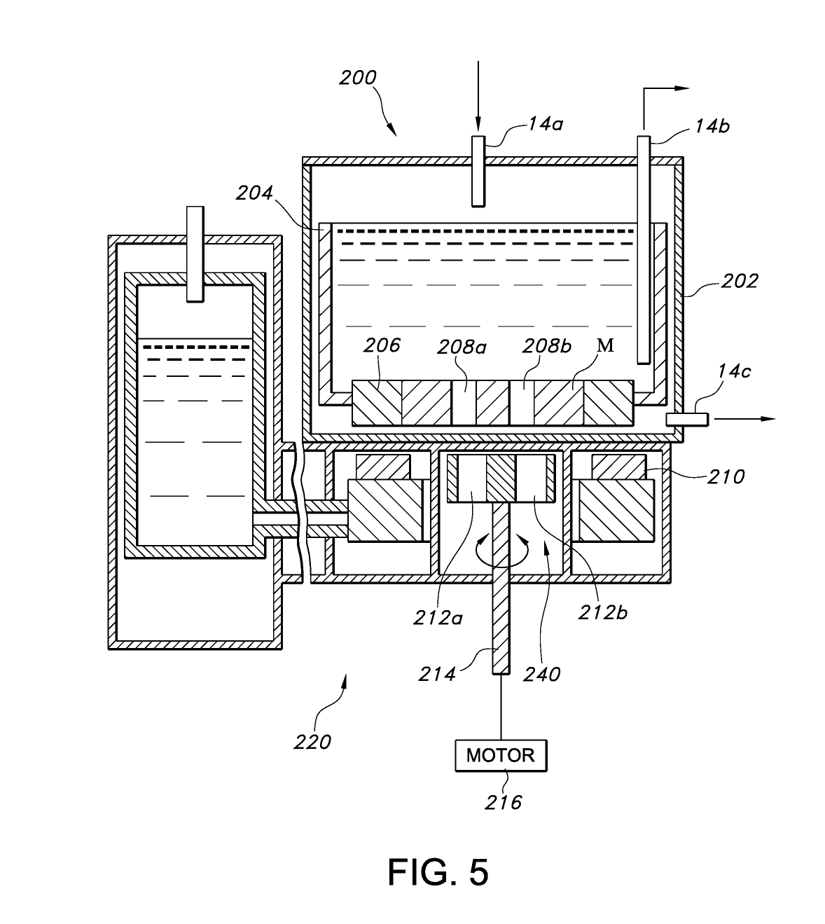

Another possible embodiment of a centrifuge system 200 is shown in FIG. 5. In this system 200, the container 204 actually includes two magnetic subsystems: a first one that serves to levitate the container 204, which includes a first magnet 206, which may be in the form of a ring, and a second magnetic subsystem that includes at least two alternating polarity driven magnets 208a, 208b, which may be positioned inside of the first, ring-shaped magnet 206, to transmit driving torque. Polarization of the ring magnet 206 is vertical, and the driven magnets 208a, 2086 are shown as being disk-shaped and having opposite or alternating polarities to form a magnetic coupling and transmit the torque to the levitating container 204. 204. Levitation magnet 206 and driven magnets 208a, 208b may be integrated in one rigid structure such as by embedding or attaching all three to a lightweight, inert matrix material M, such as plastic or the like.

To correspond to the ring-shaped levitation magnet, the motive device includes a superconducting element 210 that is generally annular. This element 210 can be fabricated of a single unitary piece of a high-temperature superconducting material (YBCO or the like), or may be comprised of a plurality of component parts or segments. Upon being cooled to the transition temperature in the presence of a magnetic field and aligning with the ring-shaped permanent magnet 206 producing the same magnetic field, the superconducting ring 210 thus provides the combined repulsive/attractive, spring-like pinning force that levitates the container 204 in the vessel 202 in an exceptionally stable and reliable fashion. In FIG. 5, the vessel 202 is shown as being supported on the outer surface of a special cryostat 220 designed for use with this system 200. However, it is within the broadest aspects of the invention to simply support the vessel 202 on any stable support structure, such as a table (not shown), as long as it remains sufficiently close to the superconducting element 210 to induce the desired levitation in the container 204 therein.

As in other embodiments described, a motive device is used to impart rotary motion to the container 204, and may be positioned adjacent to and concentric with the annular superconducting element 210. One example of a motive device for use in the system 200 of this third embodiment includes driving magnets 212a, 212b that correspond to the driven magnets 208a, 208b on the container 204 and having opposite polarities to create a magnetic coupling. The driving magnets 212a, 212b may be coupled to a shaft 214 also forming part of the motive device. The driving magnets 212a, 212b may be attached directly to the shaft 214, or as illustrated in FIG. 2, may be embedded or attached to a matrix material. By positioning the driving magnets 212a, 212b close to the container 204, such as by inserting them in the opening 240 or bore defined by the annular superconducting element 210, and rotating the shaft 214 using a motor 216 also forming a part of the motive device, synchronous rotation of the levitating container 204 is induced.

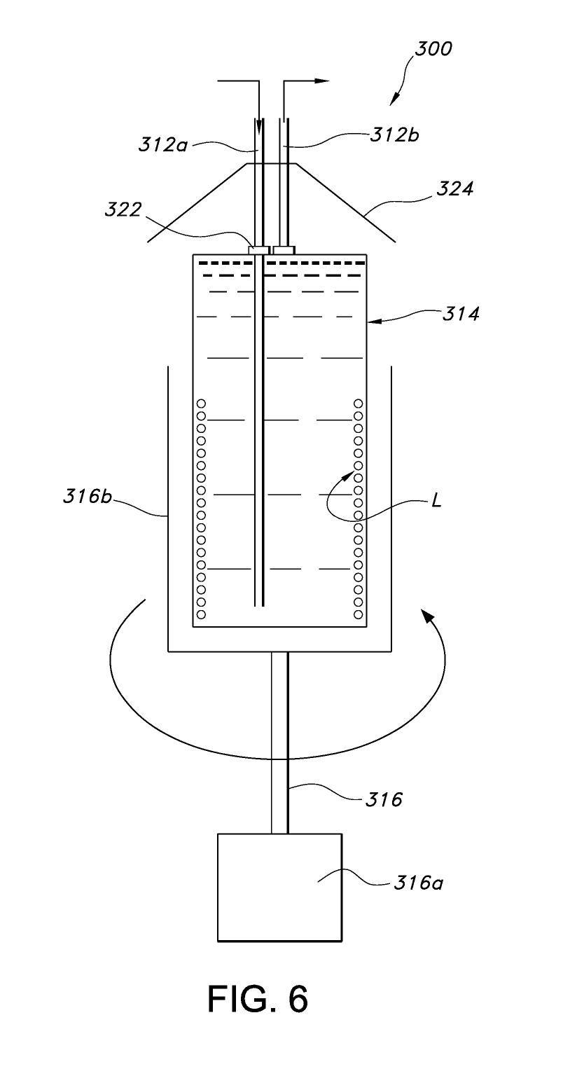

FIG. 6 illustrates a centrifuge system 300 including a container 314 supported by a motive device 316 comprising a motor 316a and a rotating platform 316b for receiving the container 314. The inlet and outlet for performing the substantially continuous flow of media is provided by conduits in the form of tubes 312a, 312b, which are connected to the container 314 by dynamic seals 322, and may be connected to a static support structure, such as a cap 324. The arrangement thus allows for the container 314 to rotate to perform centrifugation.

The arrangement is this embodiment may be used in connection with specific process parameters to ensure optimum efficiency (e.g., maximum cell separation with minimum destruction). The volume of the container may be between about 100 ml and about 300 ml, and in particular about 135 ml. The corresponding flow may be less than one liter per minute, and may be in the range of about 250 milliliters per minute (0.25 L/min) to about 500 milliliters per minute (0.5 ml/min).

In the illustrated embodiment, no extraction conduit is located in the same position as the above-described arrangements. Accordingly, the segregated cells L may be collected at the end of the centrifugation process. This recovery may be aided by using a washing step (e.g., using a trypsinisation solution comprising 1.55 L tryposin (an enzyme) to release the cells and 7.45 L of a PBS buffer solution to keep the cells alive) that have accumulated on the container walls. The container 314 may be a single use component (e.g., a disposable bag or liner), and thus may be discarded after cell recovery.

The foregoing descriptions of several embodiments made according to the disclosure of certain inventive principles are presented for purposes of illustration and description. The embodiments described are not intended to be exhaustive or to limit the invention to the precise form disclosed and, in fact, any combination of the components of the disclosed embodiments is contemplated. The term “flexible” as used herein in the context of the vessel refers to a structure of the vessel that, in the absence of auxiliary support, may conform to the shape of the fluid contained in the vessel, as contrasted with a “rigid” structure, which retains a pre-determined shape when the fluid is in the vessel. Modifications or variations are possible in light of the above teachings. For example, various materials may be used to form the vessel in any combination, including polymers (such as, for example, polypropylene for any flexible portions, and high density polyethylene for any rigid portions). The embodiments described were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention when interpreted in accordance with the breadth to which it is fairly, legally, and equitably entitled.

1. An apparatus for use in performing centrifugation on a liquid including solids, comprising:
a container including an interior compartment for receiving the liquid and solids, said container being capable of rotating to urge the solids toward the periphery of the interior compartment;
a fixed extraction conduit for extracting at least a portion of the solids from adjacent the periphery of the interior compartment of the container; and
a motive device for forming a non-contact coupling with the container.

2. The apparatus of claim 1, further including a vessel for receiving the container, the vessel including an inlet for introducing the liquid and solids to the container and a drain for draining at least liquid from the vessel.

3. The apparatus of claim 2, wherein any one of the inlet, the extraction conduit, or the drain comprises a tube connected to a wall of the vessel by a static seal.

4. The apparatus of claim 1, wherein the motive device is adapted to rotate the container via the non-contact coupling.

5. The apparatus of claim 1, wherein the motive device is adapted to levitate the container via the non-contact coupling.

6. The apparatus of claim 1, wherein the motive device is adapted to levitate and rotate the container via the non-contact coupling.

7. The apparatus of claim 1, wherein the motive device comprises a superconductor or an electromagnet.

8. (canceled)

9. The apparatus of claim 1, wherein the container includes a bottom wall and an upstanding sidewall forming an at least partially open top.

10. The apparatus of claim 9, wherein the container includes a lip adjacent the sidewall for assisting in retaining cells in the interior compartment during rotation.

11. The apparatus of claim 1, wherein the container comprises a rigid material.

12. The apparatus of claim 1, wherein the container carries at least one magnet.

13. An apparatus for use in performing centrifugation on a liquid including solids, comprising:
a vessel;
an open-ended container mounted for rotating within the vessel, the container including an interior compartment for receiving the liquid and solids; and
a motive device for rotating the container by way of a non-contact coupling, wherein the motive device comprises a superconductor connected to a motor, and the container is adapted for forming a magnetic coupling with the superconductor.

14.-15. (canceled)

16. The apparatus of claim 13, wherein a permanent magnet is adapted for rotating to rotate the container via a magnetic coupling with the superconductor.

17. The apparatus of claim 13, further including a mechanical bearing for supporting the container for rotation relative to the vessel.

18. The apparatus of claim 13, wherein the container includes a lip along an upper portion for assisting in retaining cells in the interior compartment during rotation.

19. The apparatus of claim 13, further including a fixed extraction conduit for extracting at least a portion of the solid from adjacent the periphery of the interior compartment of the container

20. An apparatus for use in performing substantially continuous centrifugation to separate cells from a liquid, comprising:
a vessel adapted for receiving the liquid; and
a container mounted for rotating within the vessel, the container including an interior compartment for receiving the liquid;
wherein the vessel includes an inlet for introducing the liquid to the interior compartment of the container, an extraction conduit for extracting cells from the interior compartment of the container, and a drain for draining at least liquid from the vessel.

21.-24. (canceled)

25. An apparatus for use in performing substantially continuous centrifugation to separate cells from a liquid, comprising:
a collapsible vessel; and
a container mounted for rotating within the vessel, the container including an interior compartment for receiving the liquid.

26.-28. (canceled)

29. An apparatus for use in performing centrifugation to separate cells from a liquid, comprising: a container mounted for rotation, the container including a first conduit for conveying the liquid to an interior compartment of the container and a second conduit for conveying liquid from the interior compartment, the first and second conduits each being connected to the container by way of a dynamic seal;
wherein a flow rate of the liquid is from about 250 ml/min to about 500 ml/min.

30.-50. (canceled)
